(19) United States
(12) Patent Application Publication
(10) Pub. No.: US 2013/0193667 A1
(43) Pub. Date: Aug. 1, 2013

(54) Access System and Device for Earthmoving Vehicles, and Modes of Employment Thereof

(71) Applicant: Nathan John Ellement, Oakford (AU)

(72) Inventor: Nathan John Ellement, Oakford (AU)

(21) Appl. No.: 13/635,908

(22) PCT Filed: Mar. 22, 2011
(86) PCT No.: PCT/AU2011/000323

§ 371 Date: Nov. 23, 2012

(30) Foreign Application Priority Data
Mar. 22, 2010 (AU) 2010901216

(51) Int. Cl. B60R 3/02

(52) U.S. Cl. CPC B60R 3/02
USPC 280/166

(57) ABSTRACT

An access system for a vehicle (42) has an access device (40) (such as a stair or ladder), an actuation mechanism for extending and retracting the access device, the access device being extendible from a contracted configuration for deployment to permit access to the equipment and retractable to a contracted configuration for normal operation of the equipment by the actuation mechanism. The access device has a multiplicity of treads to support a user thereof during use, the treads being connected such that the access device retracts by contracting with treads closing together, and wherein the actuation mechanism includes an actuation ram (50) (hydraulic, pneumatic) and linkages (52, 64, 66), and at least one pivot (68) with at least one respective pivot axis about which the access device rotates during retraction or deployment effected by operation of the ram. Thus the access device not only retracts and extends but rotates backwards for stowage under a cab or chassis of the vehicle when retracting. A deployment assistor (90), such as a gas strut, can be used to assist gravity actuated deploy of the access device.

### FIELD OF THE INVENTION

The present invention relates to access devices for earthmoving vehicles.

### BACKGROUND OF THE INVENTION

Earth moving equipment, such as graders and bulldozers have a chassis, a working tool (bucket, blade, grab, drill etc), large wheels, a protective driver cabin with access door, and some form of access or access system, such as fixed or moveable ladder or stair. The chassis includes all the mechanical parts that form the structural frame of the earth moving equipment. The driver operates the earth moving equipment from the protective driver cabin. A hatch is located behind the driver cabin and typically houses many of the important control units of the earth moving equipment vehicle such as hydraulic controls, hydraulic pump, fuse box, electrical circuit breakers etc. The access device provides access between the ground level and the cabin. Typically, though not always present, walkways are provided around the cabin area for an operator to access the hatch located behind the driver cabin of the earth moving equipment vehicle. The access device is usually attached to the walkway, chassis or cabin structure near the entry door to the cabin.

Retractable access systems of different configurations are presently known and have two final positions, namely the deployed position and the retracted position. The major types of access devices are the vertical variable height access system and the swing access system.

The vertical variable height access system would generally be used for large excavators and earth moving equipment. In the vertical variable height access system, the ladder or stairs would be operated vertically and would remain vertical both in the deployed position and retracted position. Essentially, the length of the ladder or stairs does not vary, rather, the ladder or stairs is simply lifted vertically upwards or lowered downwards.

In the swing type access system, the ladder or stairs when operated will swing (rotate) up or down to reach either the retracted position or deployed position respectively.

The basic constituents of any access system include a ladder or stairs and a mechanism to actuate the ladder or stairs. The ladder or stairs are generally made of metal such as steel or aluminium. The movement of the ladder or stairs in any access system is controlled by an actuator mechanism. The actuator mechanism moves the ladder or stairs between the deployed and the retracted position. This actuator is usually operated either mechanically, electrically or hydraulically. A combination of these means is also in practice.

Problems exist with certain types of earth moving equipment. For example, graders have at least one large blade used for levelling earth, soil, sand etc. The blade can be lifted/lowered, rotated and tilted, to allow for an initial level of the surface to be graded and/or to impart a required level to the surface. Basically the blade is set at a required angle, and the vehicle advanced over the surface such that the blade forms a particular slope or level to the surface. This is particularly prevalent when forming a level or particular sloping surface for the sides of new access roads where banks are required in virgin soil that is initially uneven. Graders are also used to re-level loose surface roads that incur holes, washout due to flooding or other disturbances that degrade the surface. These vehicles have a cabin for the operator immediately behind and above the blade. This position allows the operator to oversee the blade position and grading as the vehicle advances. However, because the cabin is above and between the blade to the front and the rear wheel behind, any access means has to extend downwards between the blade and rear wheel to permit access/egress. The blade of a grader is sufficiently manoeuvrable that the access means can be damaged or removed by impact from the blade swinging against the access means.

A previously proposed solution to one or more of the above problems has been disclosed by the present applicant in their international (PCT) application number PCT/AU2009/000296 published as WO 2009/114897, the contents of which are herein incorporated in their entirety by reference.

Where the cab of the grader is generally square or rectangular, with an access door immediately to the side (rather than on a forward facing oblique angle), the retracted access means can get trapped between the forward-most wheel of the rear wheels on that side of the vehicle and the chassis/blade when the vehicle is articulating. That is, when the driving end of the grader (including the engine) articulated about a pivot point below the driver operator's cabin with respect to the working end holding the blade.

With the aforementioned in mind, it would be desirable to provide a retractable access device for earth moving equipment that is space saving in a retracted position, and preferably less prone to being damaged when retracted.

### SUMMARY OF THE INVENTION

With the aforementioned in view, one form of the present invention provides an access system for a vehicle, said system having an access device for mounting to the vehicle and an actuation mechanism for extending and retracting said access device, the access device being extendible from a contracted configuration for deployment to permit access to the equipment and retractable to a contracted configuration for normal operation of the equipment by the actuation mechanism, the access device including a multiplicity of treads to support a user thereof during use, the treads being connected such that the access device retracts by contracting with the treads closing together, and wherein the actuation mechanism includes at least one pivot including at least one respective pivot axis about which the access device rotates during retraction or deployment.

Consequently, and advantageously, the access device not only retracts to reduce its storage footprint but also rotates to store inwardly towards the chassis and towards an underside of the cab of the grader.

The actuation mechanism may rotate the access device through up to 90° from a 0° storage position to a 90° deployed position. Preferably the deployed position is approximately 80° rotation with respect to the (retracted) storage position. The actual degree of rotation will be understood to vary with the size and type of vehicle and length of the access device.

According to one or more preferred forms of the present invention, one or more hydraulic or pneumatic rams, or an electric motor, drives the actuation mechanism. In the case of hydraulic or pneumatic ram(s), the ram(s) are connected through a linkage to the access device and the geometry of the linkage with respect to the access device and to the pivot axis may determine the amount of rotation with respect to the amount of deployment/retraction.

From a deployed position with the treads of the access device generally horizontal for normal use, the access device may be retracted such that the treads close together during retraction and also rotate away from horizontal until they are nested and stored angled upward/downward. The access device therefore may be stored generally under the cab of a grader rather than predominantly extending outwardly even when retracted.

Thus, the access device may utilise space under a portion of the cab of a grader and prevent the access device from being damaged by being trapped between a front-most tyre of the rear wheels and blade of the grader.

A further aspect of the present invention provides an access system for a vehicle, said system having an access device for mounting to the vehicle, and a mechanism for extending and retracting said access device, the access device being extendible from a contracted configuration for deployment to permit access to the equipment and retractable to a contracted configuration for normal operation of the equipment, the access device including a multiplicity of treads to support a user thereof during use, the treads being connected such that the access device retracts by contracting longitudinally with the treads closing together.

Beneficially, the access device contracting longitudinally permits the treads to close closer together, for example, in a concertina type arrangement, to a relatively compact form such that the access device is clear of the ground and does not require rotation to longitudinally position laying next to the cabin or up in the air. Such compact contraction saves space, and can permit the cabin door to open and close whilst the access device is retracting or deploying. This is especially useful where the access device is employed on a grader by helping to avoid potential damage from the blade and/or damaging the cabin door during retraction/deployment.

Deployment is preferably a reverse of the retraction arrangement.

In a preferred form, the access device may contract or extend in a concertina or scissor arrangement.

The treads may retract to a nested configuration with one tread overlaying the next, such as for improved compact storage.

Two or more of the treads may be interconnected by pivot linkages. The pivot linkages may include at least one link member pivotably connected at each end thereof to a respective tread.

Preferably a pair of link members may be pivotably mounted at each end of each member to each side of a respective tread to form a four bar linkage for each side between two consecutive treads.

The access system may include at least one handrail mounted to the access device. For example, at least one, preferably multiple, handrails may be mounted to the access device, and preferably each handrail may nest with an adjacent handrail when the access device is retracted. A handrail may be provided on one or more sections of a sectional access device, where each section has at least one tread unit including one or more treads.

Another form of the present invention provides an access system for a vehicle, including a sectional access device, each section including at least one tread unit having at least one tread for supporting a user and each section articulatory connected to at least one other said section by articulation connections such that the tread units close together during upward longitudinal retraction of the access device from a downwardly extended deployed orientation.

The sections may close together to form retracted access device with the tread units nested together.

Another form of the present invention provides a method of retracting a deployed access device for earth moving equipment, the access device including a multiplicity of treads for supporting a user, the method including bringing the treads closer together during a longitudinal contraction of the deployed access device.

Contraction of the access device may nest the treads adjacent one another in a retracted configuration.

The treads may be successively connected by respective linking means such that apply a force to retract the access device acts through the linking means to retractably bring the treads together.

The linking means may be linking members forming four bar linkages at either side of the treads, and retracting one tread causes a retraction force to be applied through the linkages to retract the connected tread or treads in a longitudinal direction of the access device.

Another form of the present invention provides a retractable access device for a vehicle, the access device having a longitudinal extent when deployed, and including a multiplicity of treads interconnected in series by connectors pivotably mounted with respect to the treads, the connectors permitting the access device to contract longitudinally.

Four bar type linkages may be used to connect the treads together. These may be provided either side of the treads. Consequently, a force applied to retract the access device, applied to or adjacent one tread, may be transferred through the connectors to the other treads, thereby bringing the treads closer together to a retracted configuration.

An access device according to one or more forms or embodiments of the present invention has treads that are connected such that they close together along an access device retraction axis, preferably whilst remaining in parallel.

The earth moving equipment is preferably a grader, which has particular issues and difficulties for access systems. The blade of a grader has an extensive range of movement, such that an extended/deployed access device (such as a set of steps or ladder) can be damaged or knocked off of the grader by the blade, even when retracted. Consequently an access system or device, such as an extending ladder or steps, needs to be compact when retracted to avoid the blade being moved to a position which would damage the ladder or steps. It is possible to punch the cabin windows out of the vehicle cabin with the blade and/or damage the door and/or steps if not operated correctly, as does happen. Also, it is desirable that the access device is sufficiently compact when retracted so as not to impede movement of the cabin door, such as for emergency egress of the operator or ventilation/protection when necessary.

It is also preferred that the access device have minimal effect on the visibility out of the machine when retracted

### BRIEF DESCRIPTION OF THE DRAWINGS

FIGS. 1a to 1d show various views of a section of an access device according to an embodiment of the present invention in extended/deployed configuration.

FIGS. 2a to 2d show various views of a section of an access device according to an embodiment of the present invention in partial extended/deployed configuration.

FIGS. 3a to 3d show various views of a section of an access device according to an embodiment of the present invention in retracted/contracted configuration.

FIGS. 4a to 4d show various views of a section of an access device according to an embodiment of the present invention in extended configuration, the access device including handrails.

FIGS. 5a to 5d show various views of a section of an access device according to an embodiment of the present invention in partially retracted configuration, the access device including handrails.

FIGS. 6a to 6d show various views of a section of an access device according to an embodiment of the present invention in retracted configuration, the access device including handrails.

FIG. 7a shows an access device according to an embodiment of the present invention in deployed mode on a grader.

FIGS. 7b to 7d show an access device according to an embodiment of the present invention in partially retracted mode on a grader.

FIGS. 8a to 8c show an access device according to an embodiment of the present invention in retracted mode on a grader.

FIGS. 9a to 9d show an access device according to an embodiment of the present invention during various stages of retraction and rotation.

FIGS. 10a to 10d show the access system according to an embodiment of the present invention in closer detail in various stages from extended to retracted, though not mounted to a grader.

FIGS. 11a to 11l show the access device according to an embodiment of the present invention in various stages of deployment/retraction.

FIGS. 12a to 12c show a top section of the access system according to an embodiment of the present invention. FIG. 11a shows the access device (such as a stair) extended. FIG. 11b shows the access device partially retracted, and FIG. 11c shows the access device fully retracted and rotated back.

Particular embodiments of the present invention will hereinafter be described, including with reference to accompanying figures. It will be appreciated that the embodiments described do not limit the generality of the present invention.

### DESCRIPTION OF PREFERRED EMBODIMENTS

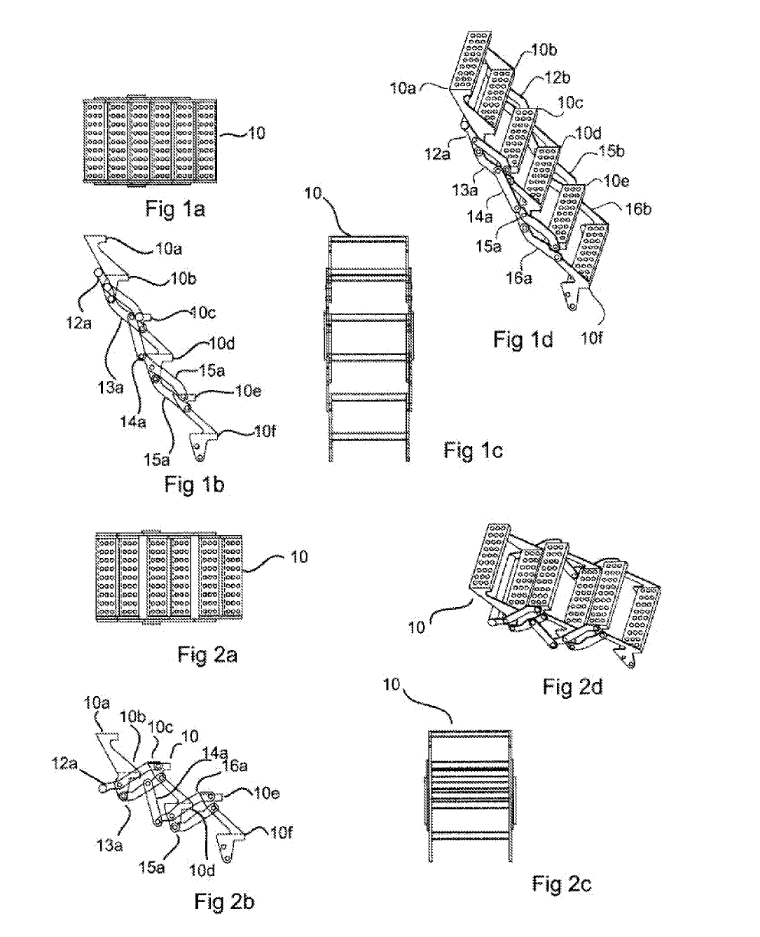

FIGS. 1a to 1d show various views of a section of an access device according to an embodiment of the present invention in extended/deployed configuration. It will be appreciated that the section of the access device, in this instance a set of steps or stair for a grader vehicle, can be extended in length by adding additional repeatable portions. The steps 10 include individual treads 10a-10f. These are pivotably linked by connectors 12a . . . 16b, which can be extended by addition of further connectors if a longer set of steps is required for a particular application. The connectors can act as four bar linkages to allow the steps to concertina closed, as shown through stages FIGS. 2 (partially closed) and 3 (fully closed).

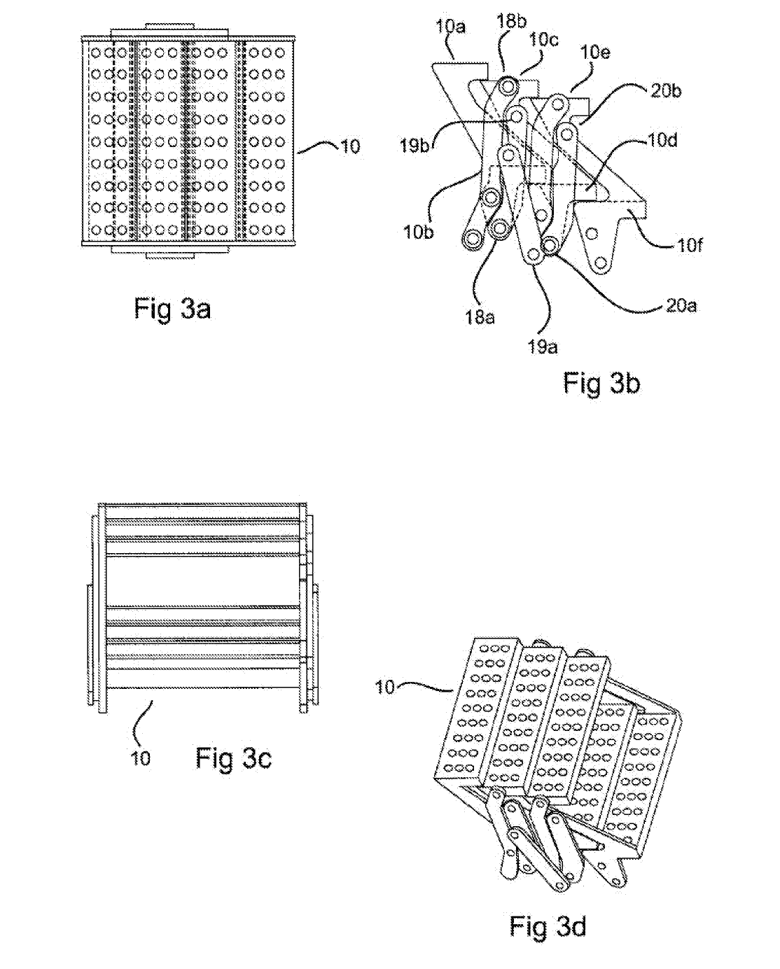

FIG. 2b in particular demonstrates the longitudinal contraction/extension properties of the steps. The side connectors allow fixed pairs of treads to concertina in unison, such that they nest together, as shown in FIG. 3b. The top tread 10a, 10c, 10e of each pair partially overlays the top tread of the adjacent pair. Likewise, the bottom tread 10b, 10d, 10f of each pair partially overlays the respective bottom tread of the adjacent pair. The connectors (or linkages) collapse/open in a scissor like pivoting action, somewhat like the action of expandable lattice/trellis. This arrangement of the present invention permits the steps to take up reduced storage space once collapsed, but are readily extended by applying an opening force action at any point, preferably in an area near the top or bottom of the step run. FIGS. 3a-3d show a fully collapsed/contracted configuration of the steps.

The linking connectors are provided at the respective sides of the treads. Thus, the pair of risers connecting one step to another of a pair, and their respective side connectors for a four bar linkage for each side to permit collapse of one pair towards or extension away from the next adjacent pair. The connectors are attached at pivot points, such as at 18a to 20b. Other pivot points are ensilaged, as shown.

In use, the steps are mounted to a vehicle, such as a grader. An actuator mechanism, such as a hydraulic ram, or electrical motor is used to deploy the steps from a collapse/contracted position. The connectors, which can be termed linkages, allow the steps to concertina open and thus extend longitudinally downwards. Once deployed, a user can climb/walk up the treads. To retract the steps, the reverse procedure is employed. The actuator mechanism, or a return spring mechanism, or combination of both to ease retraction forces of the weight of the steps due to gravity, returns the steps to a collapsed/contracted configuration. Thus the steps are nested together in a closed position with the steps effectively raised from the ground at a position close to the cabin adjacent the top tread.

The blade of a grader can move to almost any position, consequently an access system or device, such as an extending ladder or steps, needs to be compact to avoid the blade being moved to a position which would damage the ladder or steps. It is possible to punch the cabin windows out of the vehicle cabin with the blade and/or damage the door and/or steps if not operated correctly, as does happen.

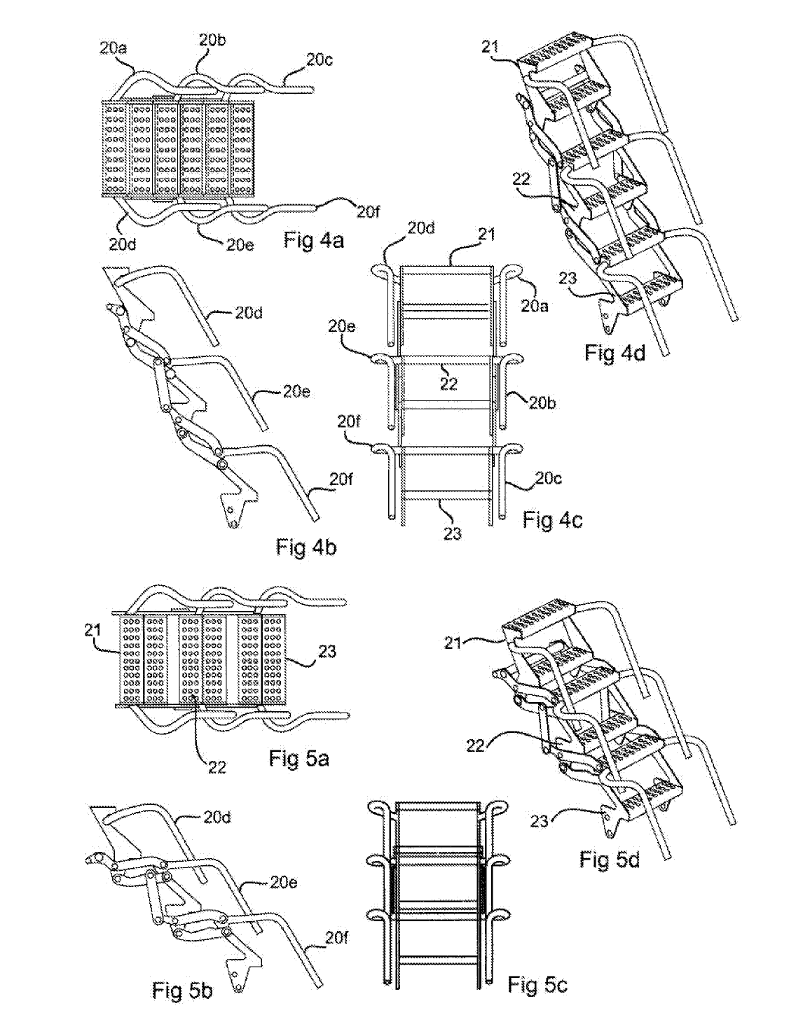

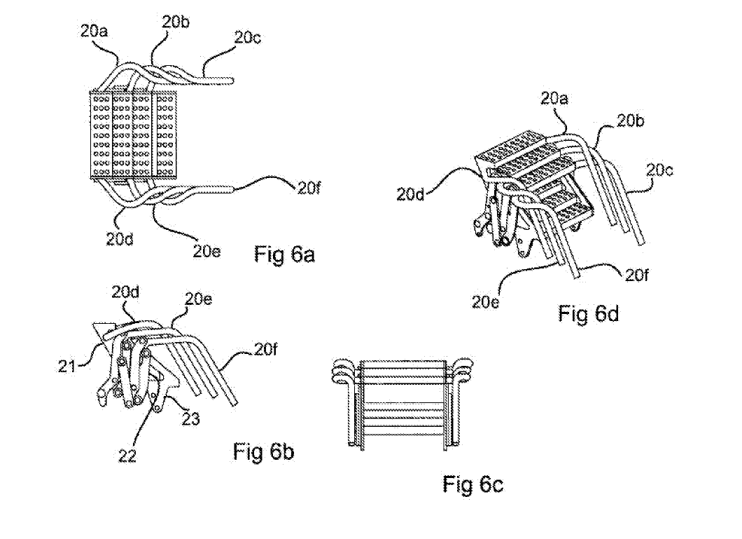

FIGS. 4a through 6d show deployment/retraction stages of the device corresponding to FIGS. 1a to 3d, except that the set of steps has multiple handrails 20a to 20f. It will be appreciated that fewer, longer handrails may be fitted, or more handrails, especially where the access device is longer with a greater number of sections 20, 21, 23. The sections provide tread units, in this instance each tread unit having two treads or steps. These sections are hinged or otherwise articulatory connected to at least one other section. It will be appreciated that the topmost and bottom most section will only be connected to its next adjacent section, whereas intermediate sections connect to at least one above and at least one below. FIGS. 4a to 6d show snapshots of stages during retraction of the access device, or deployment if taken in reverse. The handrails nest together for the collapsed, retracted position. That is they interfit within one another to a compact “stacked” arrangement.

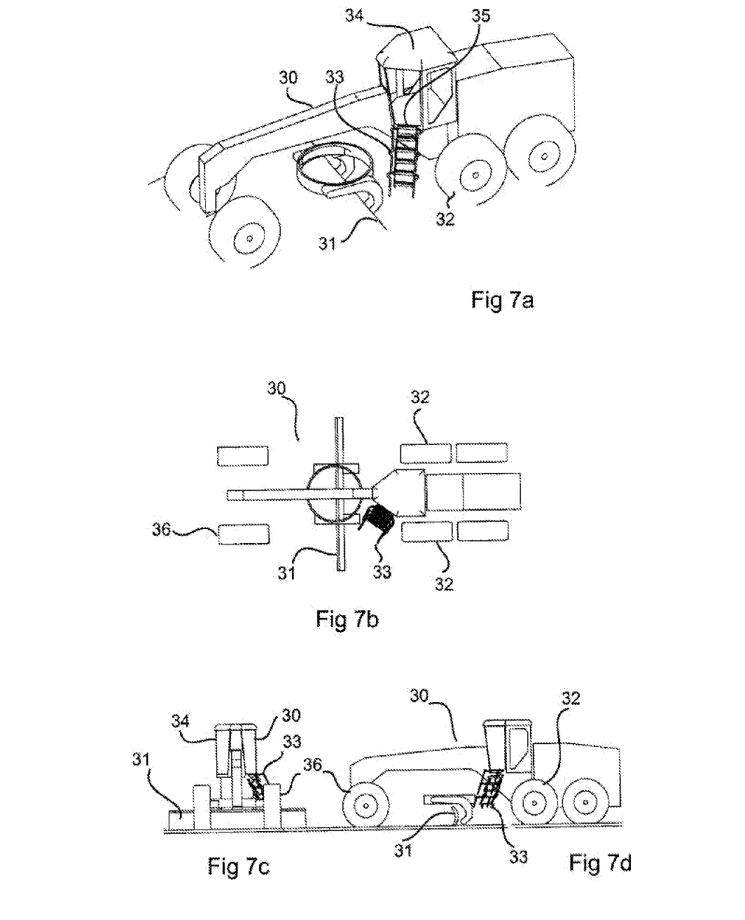

FIG. 7a shows the access device (steps) 33 in a deployed configuration on a grader 30. The steps are clearly seen extending downwards between the rear wheel 32 and the grader's blade 31. The steps are mounted to the sill 35 entering the operator's cabin 34.

FIGS. 7b to 7d show the steps in partially retracted configuration as they are folded up towards their compact retracted position for movement of the vehicle.

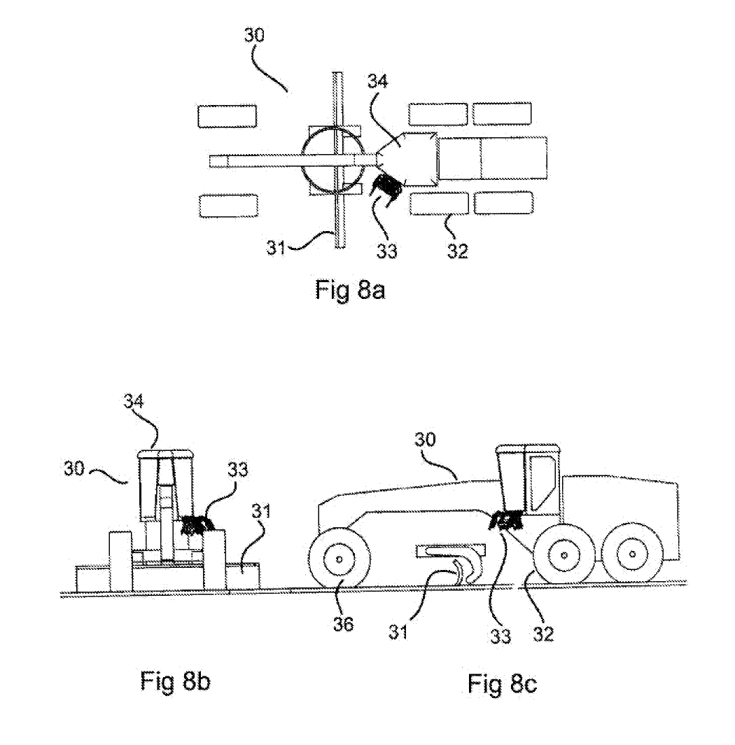

FIGS. 8a to 8c show the access device retracted in a stowed position for movement of the vehicle. The sections and tread units are compactly nested together due to the pivoting articulation members connecting consecutive sections. These allow the tread units to nest such that the top tread of one unit rests adjacent the top tread of an adjacent unit, and the bottom tread of a unit rests adjacent the bottom tread of an adjacent unit. Similarly, the handrails, where fitted, are shaped so as to allow one to fit through the next for compact stowage.

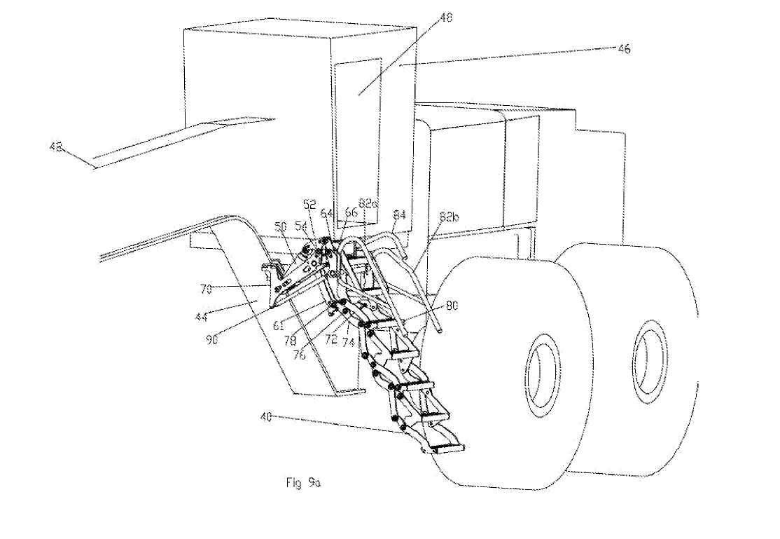

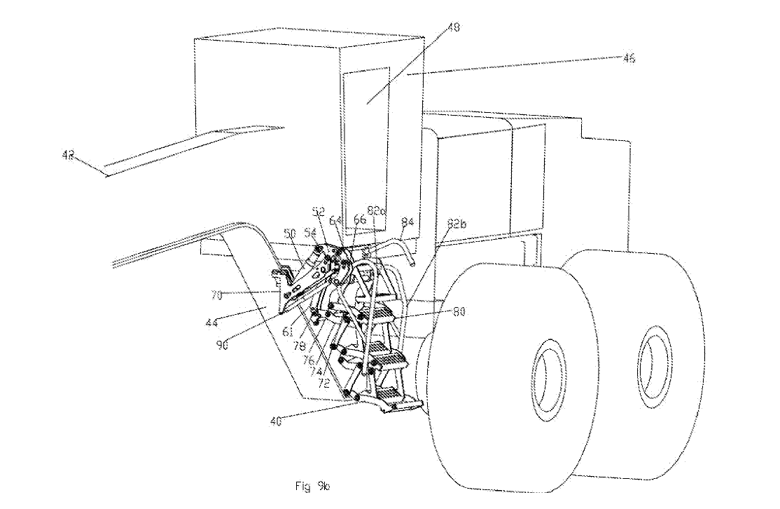

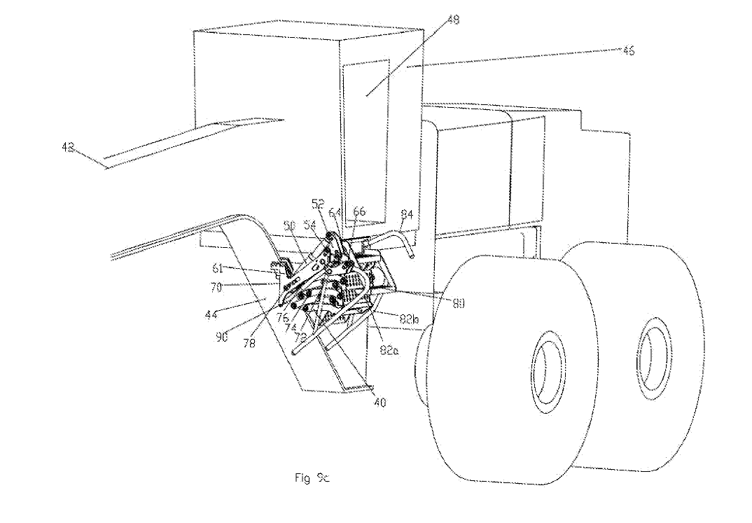

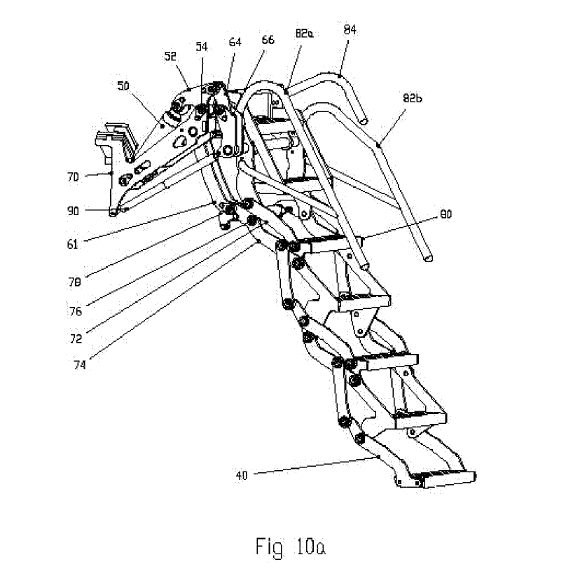

FIGS. 9a to 9d show the access device 40 mounted to a grader 42 and showing in stages the access device being moved from a deployed position (FIG. 9a) to a retracted position (FIG. 9d). As can be seen, the access system is mounted to a portion of a chassis 44 of the grader. The access system including the actuation mechanism stores generally underneath the cab 46. The cab is of a common generally square or rectangular footprint with the access 48 to the immediate side of the grader.

A ram 50 of the actuation mechanism operates a linkage 52 via a pivot 54. The linkage causes the access device (ladder or stair) to retract/deploy and to rotate. Thus the access device opens out from a retracted position (with the treads nested) and angled upwards/downwards to a deployed, opened out position, with the treads generally horizontal (presuming the vehicle is on level even ground).

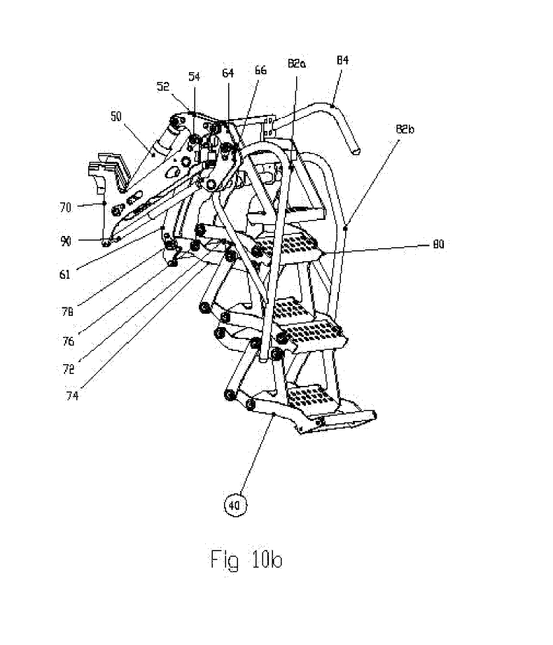

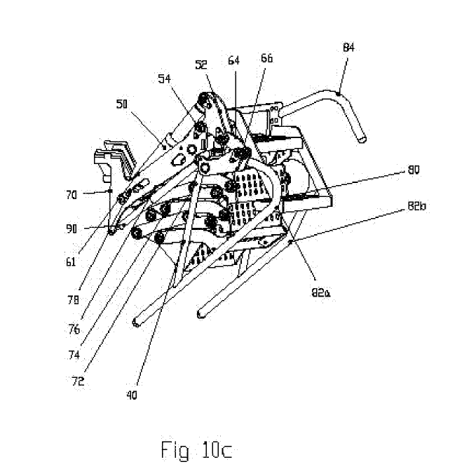

FIGS. 10a to 10d show the access system stair 40 in closer detail in various stages from extended to retracted, though not mounted to a grader. As is shown, through operation and connection of the side linkages between tread assemblies, the uppermost treads 10a, 10b remain static, the lowermost tread rotates in the opposite direction to the intermediate treads 10c-10f. Thus the lowermost tread can nest into space between intermediate treads. During this retraction, the whole arrangement of treads rotates backwards (in direction A) such that the intermediate and lowermost treads do not project forward further than the assembly with the uppermost treads.

The ram 50 acts through linkage arm 52 and further linkages 56 to effect a particular retraction/extension and rotation of the access device. The geometry of these linkages can be varied to suit particular applications.

Advantageously, the access system can mount to a chassis of the grader via a single point mount 60 and a mounting plate 62.

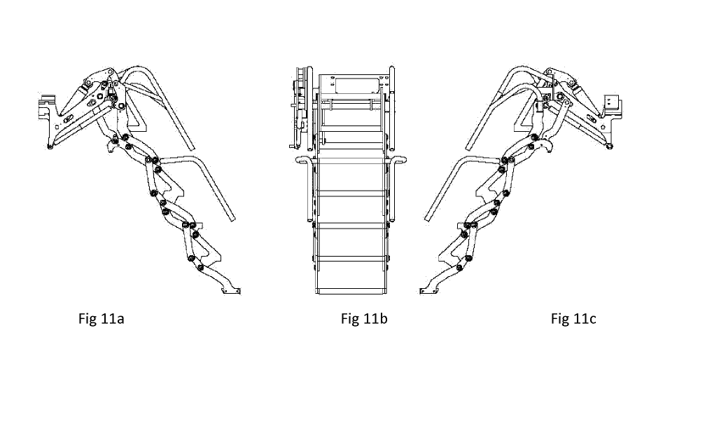

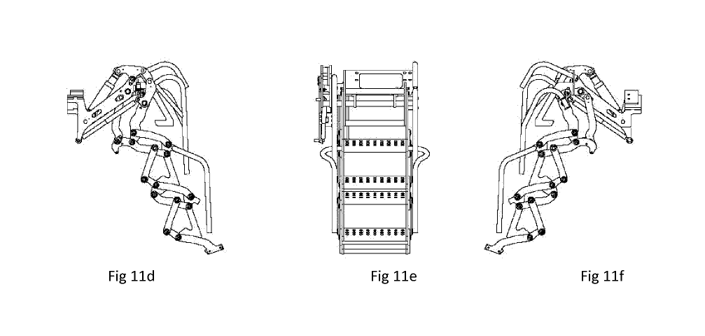

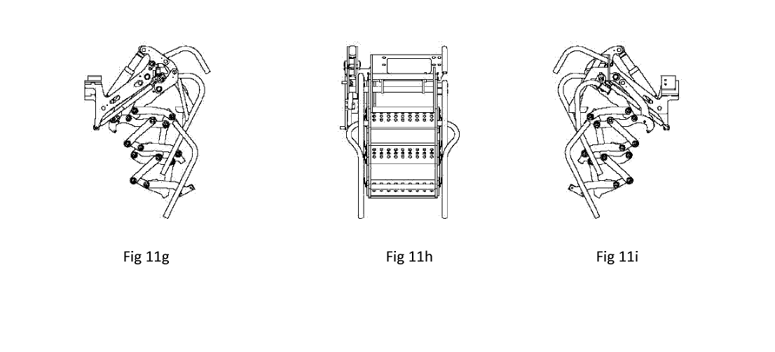

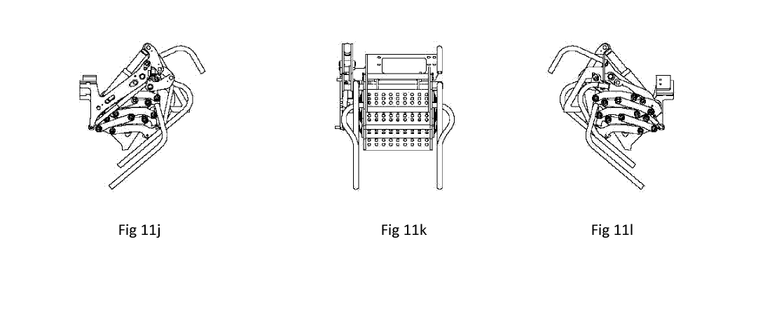

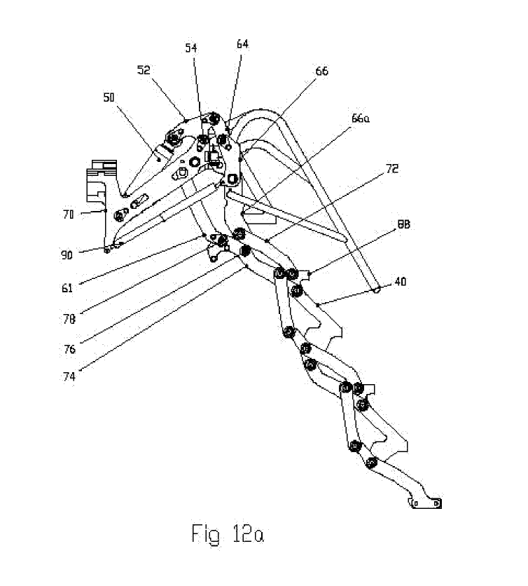

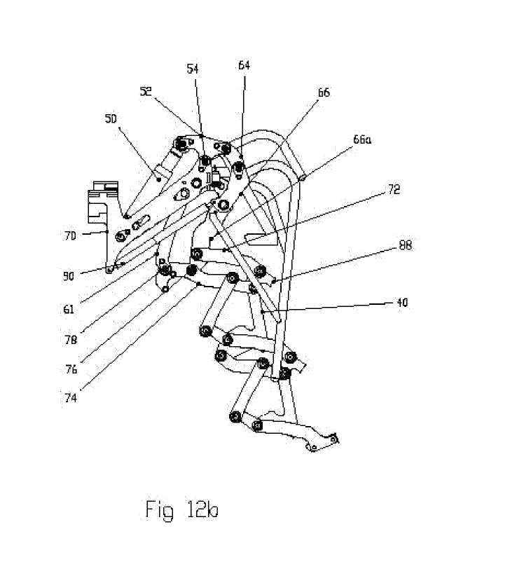

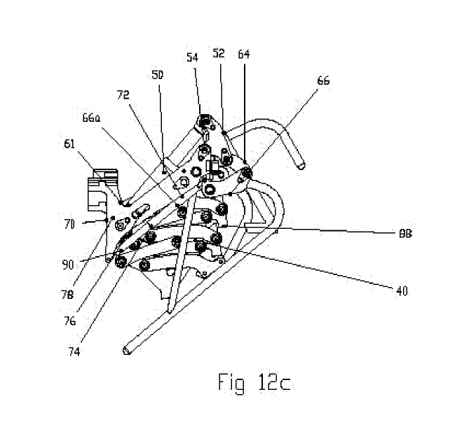

FIGS. 12a to 12c show an upper section of the stair 40 in various stages of deploy/retraction. FIG. 11a shows the stair 40 fully extended with the ram 50 retracted. One end of the ram 50 is mounted to a static portion of the system that is itself mounted to the chassis of the vehicle. A distal end of the linkage arm 52 acts on further linkages. The linkage arm 52 is a rocker linkage pivotably connected to a link rocker 64. An opposite end of the link rocker is pivotably connected to an adapter link 66. The adapter link 66 has an adapter link extension 66a fixedly connected thereto. Movement of the linkage arm 52 to rotate about a linkage arm pivot 54 may be effected by gravity acting on the mass of the access device or by powered means, such as a powered ram. Thus, the linkage arm is caused to act as a rocker. Link rocker 64 transfers the motion of the linkage arm to the adapter link, and thereby to the adapter link extension. An upper end of the adapter link is pivotably connected to a main pivot 68 through the mount 70. Movement through the aforementioned linkages causes the adapter link to rotate via the main pivot 68 backwards towards the vehicle. Movement to deploy the access device may be effected by a powered means, such as the ram 50 (e.g. as a double acting ram) or by gravity (and the ram 50 extends un-powered). An intermediate portion towards a distal end of the adapter link is pivotably connected to a first link 72. A distal end of the adapter link 66 is pivotably connected 76 to a second link 74. The second link 74 is pivotably connected 78 to a retraction link 61. An upper end of the retraction link is pivotably connected 80 to the mount 70. The first and second links are also connected at their respective distal ends to a first retractable tread 80. Action of the ram 50 through the aforementioned linkages causes the first and second links to retract the stair. The retraction link 61 is effectively longer than the adapter link 66, creating a non-parallel four bar link, and thereby causing the stair to retract by movement of the retraction link about the pivot 80 to the mount 70. Because the adapter linkage 66 is also connected to the linkage arm 52 via the rocker link 64, the stair is also caused to rotate backwards via main pivot 68 to bring the retracting stair under the cab of the vehicle. Deployment (extension) of the stair (access device) is a reversal of the retraction movement. The ram retracts and the stair rotates forward and extends to deploy. It will be appreciated that the aforementioned linkages and components are repeated on each side of the stair. Only a single ram (either single acting or double acting) may be used.

First handrails 82a (left) and 82b (right) are mount to the adapter link 66 at each respective side of the access system. These handrails rotate backwards with retraction of the stair and rotate forwards with deployment of the stair. Upper fixed handrails 84 may also be provided. The fixed handrails are connected to the fixed mount 70 and do not rotate. A second (lower) set of handrails may be connected to the first retractable tread 80. The first and second handrails may be shaped so as to not interfere with one another during the access device retraction and extension movements.

A deployment assistor may be provided to ensure that the access device fully deploys, such as during an emergency shutdown of power from the vehicle. For example, a gas strut 90 may be connected between the mount 70 and the adapter link 66. A gas strut houses a gas under pressure in a cylinder providing a push out force on a piston and associated piston rod. When the access device is deployed by gravity i.e. un-powered deployment, the push out force of the gas strut assists in ensuring that the access device fully deploys. This is particularly beneficial when the ram 50 is a single acting ram that is not providing a push out force during extension of the access device. Gravity, with assistance from the gas strut when provided, acts to deploy the access device. Retraction of the access device may then be effected by extension of the ram. A double acting ram may not require assistance from a gas strut because deployment and retraction actions would both be powered.

1. An access system for a vehicle, said system having an access device for mounting to the vehicle and an actuation mechanism for extending and retracting said access device, the access device being extendible from a contracted configuration for deployment to permit access to the equipment and retractable to a contracted configuration for normal operation of the equipment by the actuation mechanism, the access device including a multiplicity of treads to support a user thereof during use, the treads being connected such that the access device retracts by contracting with the treads closing together, and wherein the actuation mechanism includes at least one pivot including at least one respective pivot axis about which the access device rotates during retraction or deployment.

2. A system according to claim 1, wherein the retraction mechanism operates to rotate the access device inwardly towards the chassis to a stored position below a cab of the vehicle.

3. A system according to claim 1, wherein the vehicle is a grader used for levelling or profiling the ground surface.

4. A system according to claim 1, wherein the actuation mechanism operates to rotate the access device through up to 90° from a 0° storage position.

5. A system according to claim 4, wherein the deployed position is approximately 75° to 85° to rotation with respect to the storage position.

6. A system according to claim 5, wherein the rotation is up to 80°.

7. A system according to claim 1, including one or more hydraulic or pneumatic rams, or an electric motor, connected through a linkage to the access device and geometry of the linkage with respect to the access device and to the pivot axis determines amount of rotation of the access device with respect to the amount of extension of the access device during deployment/retraction of the access device.

8. A system according to claim 1, including at least one handrail connected to a component of the actuation mechanism, the at least one handrail arranged to rotate backwards for storage with retraction and rotation of the access device, and to rotate forwards with deployment of the access device.

9. A system according to claim 1, wherein the actuation mechanism is assisted by a deployment assistor during gravity effected deployment of the access device.

10. A system according to claim 9, wherein the deployment assistor includes a gas strut providing a push out force.

11. A system according to claim 1, wherein the access device is deployed by gravity acting on the access device, and retracted by operation of a hydraulic or pneumatic cylinder or ram or by an electric motor.

12. A system according to claim 1, the actuation mechanism including a linkage arm connected to a link rocker, an opposite end of the link rocker pivotably connected to an adapter link, the adapter link including an adapter link extension, the link rocker transfers the motion of the linkage arm to the adapter link, and thereby to the adapter link extension, an upper end of the adapter link is pivotably connected to a main pivot through a vehicle mount, and movement through the aforementioned links causes the adapter link to rotate via the main pivot backwards towards the vehicle, the adapter link includes an intermediate portion towards a distal end of the adapter link pivotably connected to a first link, a distal end of the adapter link is pivotably connected to a second link, the second link is pivotably connected to the retraction link, and an upper end of the retraction link is pivotably connected to the mount, the first and second links are connected at their respective distal ends to a first retractable tread, movement through the aforementioned links causes the access device to retract.

13. A system according to claim 12, wherein the adapter linkage is connected to the linkage arm via the rocker link such that, in use, the access device is caused to rotate backwards via the main pivot to bring the retracting stair below the cab of the vehicle.

14. A system according to claim 11, wherein the ram is either a single acting or double acting ram.

15. A method of retracting a deployed access device for earth moving equipment, the access device including a multiplicity of treads for supporting a user, the method including bringing the treads closer together during a longitudinal contraction of the deployed access device and rotating the access device to a stored position.

16. A method according to claim 15, whereby, from a deployed position with the treads of the access device generally horizontal for normal use, the access device is retracted such that the treads close together during retraction and also rotate away from horizontal until they are nested and stored angled upward/downward with respect to horizontal, the access device stored below the cab of the vehicle.
